(19) United States
(12) Patent Application Publication
(10) Pub. No.: US 2006/0022374 A1
(43) Pub. Date: Feb. 2, 2006

(54) Processing method for making column-shaped foam

(75) Inventors: Ching Hsi Chen, Taichung City (TW); Hung-Tse Chu, Taichung City (TW)

Correspondence Address: TROXELL LAW OFFICE PLLC;SUITE 1404, 5205 LEESBURG PIKE, FALLS CHURCH, VA, 22041, US

(73) Assignees: Sun Turn Industrial Co., Ltd.; Sun Own Industrial Co., Ltd.

(21) Appl. No.: 10/900,296

(22) Filed: Jul. 28, 2004

(51) Int. Cl. B29C 37/02

(52) U.S. Cl. 264/138

(57) ABSTRACT

A processing method for making column-shaped foam includes a first step of preparing long-shaped square foam preset in shape. The long-shaped square foam is positioned on the material-feeding device of a planing machine to be planed. The planing device is pivotally fixed with a rotary knife base fitted thereon with plural planing knives of different lengths and having planing positions. When the long-shaped square foam is pushed to the knife base to be planed, the planing knives will carry out planing in sequence, able to quickly plane the long-shaped square foam into column-shaped foam with a smooth circumferential surface. The column-shaped foam made in this way has excellent functions of floating on water, shock absorption and buffering, able to be employed for making various related products.

### BACKGROUND OF THE INVENTION

1. Field of the Invention

This invention relates to a processing method for making column-shaped foam, particularly to one having long-shaped square foam planed by a planing device to form column-shaped foam which has functions of floating, shock absorption and buffering and can be employed for making various related products, quick in processing and having excellent quality.

2. Description of the Prior Art

Foam materials are light and have function of shock absorption so they are widely employed for making various related products. Especially, column-shaped foam made of foam materials are extensively used nowadays. A conventional method of making column-shaped foam is to have a foam material continuously injection molded into column-shaped foam by means of an injection molding machine, but the column-shaped foam produced in this way is formed in the interior with comparatively large open air bubbles, therefore, it has water-absorbing power and cannot be widely applied to products that require buoyancy. Further, such column-shaped foam is insufficient in roundness and superficially rough and lacks resilient power, devoid of good functions of shock absorption and buffering.

In view of these drawbacks, another conventional processing method for making column-shaped foam, as shown in FIG. 1 (a) to (e), includes a first step of making a foam board 1 with a preset thickness per batch. Next, based on the length of column-shaped foam required, the foam board 1 is compressed and cut into several roughly shaped round blocks 2, which are then piled on each other and glued together to form a roughly-shaped half-finished object 3 having a length equivalent to that of required column-shaped foam 6. Lastly, the roughly shaped foam 3 is ground into required column-shaped foam 6 by the emery wheels 5 of an emery grinder 4. The foresaid foam board 1 produced per batch is formed in the interior with fine and closed air bubbles so it is impossible to absorb water, applicable to various products requiring buoyancy. In addition, such column-shaped foam 6 is comparatively hard and provided with excellent functions of shock-absorption and buffering, able to be employed for products requiring shock-absorption and buffering.

However, the above-mentioned conventional method of making column-shaped foam 6 by having foam boards 1 cut, piled and glued, compressed and ground has the following defects.

1. The producing process includes steps of compressing, cutting into round blocks, bonding with glue, compressing and grinding, necessary to take a long time for processing and increasing producing cost.

2. In a grinding process, it is easy to produce fine dust floating about, likely to pollute environment and endanger workers' health.

### SUMMARY OF THE INVENTION

The objective of the invention is to offer a processing method for making column-shaped foam, including a first step of positioning long-shaped square foam on the material-input device of a planing equipment to be planed. Then the long-shaped square foam is pushed to a knife base that is rotatable and provided with a plurality of planing knives having different lengths and arranged at different locations. When the long-shaped square foam is pushed to the knife base, the different-positioned planing knives on the blade base will be actuated to carry out planing in sequence, able to quickly plane long-shaped square foam into a column-shaped foam with a smooth circumferential surface.

The processing method for making column-shaped foam in the present invention not only can carry out planing and shaping quickly, but also can make a column-shaped foam that has a smooth circumferential surface and has excellent functions of floating on water, shock absorption and buffering, able to be employed for making various related products and having great industrial practicability.

### BRIEF DESCRIPTION OF DRAWINGS

This invention will be better understood by referring to the accompanying drawings, wherein:

FIG. 1 (a) to (e) is perspective and front views of a conventional process of making column-shaped foam:

FIGS. 2 (a) and (b) are perspective and front views of a process of making long-shaped square foam in the present invention:

FIG. 3 is a block diagram of a process of making column-shaped foam in the present invention:

FIG. 4 is a side view of a planing machine in the present invention:

FIG. 5 is a partial perspective view of a material-feeding device in the present invention:

FIG. 6 is a perspective view of the planing device and its front and rear portion in the present invention:

FIG. 7 is a side cross-sectional view of the planing device in the present invention;

FIG. 8 is a partial exploded perspective view of the planing knives provided on a knife base in the present invention:

FIG. 9 is a developing view showing the mutual relation between the planing portions of the planing knives and an object to be planed in the present invention:

FIG. 10 is a side cross-sectional view of the planing device in a planing condition in the present invention:

FIG. 11 is a perspective view of a long-shaped square foam planed into a column-shaped foam in the present invention: and

FIG. 12 is a perspective view of a finished column-shaped foam product in the present invention:

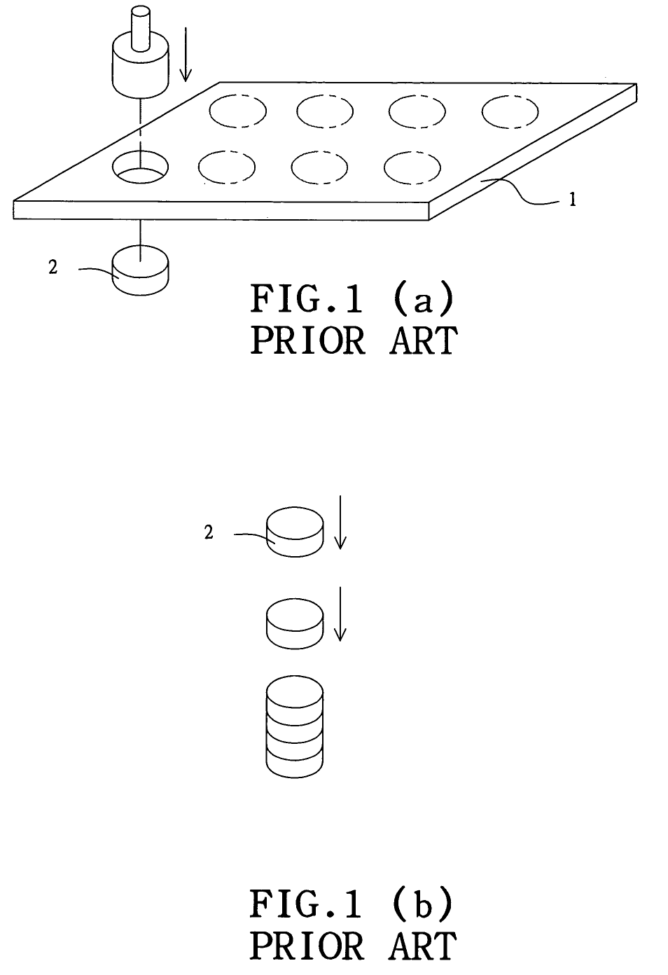

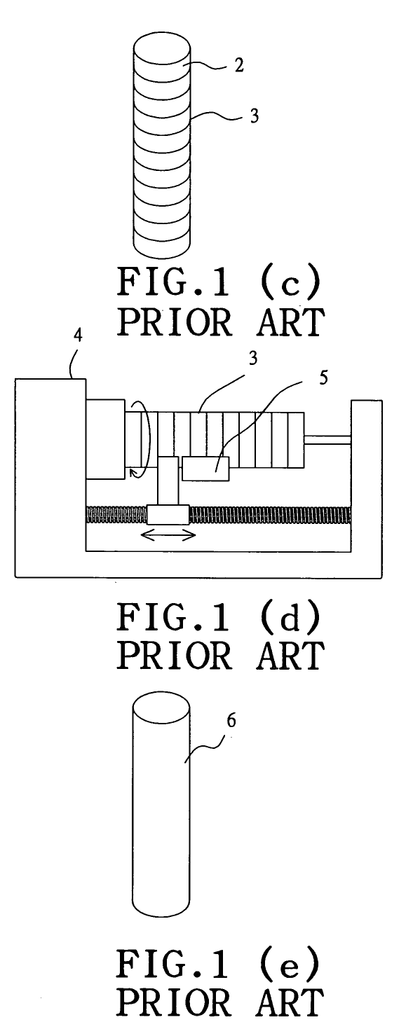

### DETAILED DESCRIPTION OF THE PREFERRED EMBODIMENT

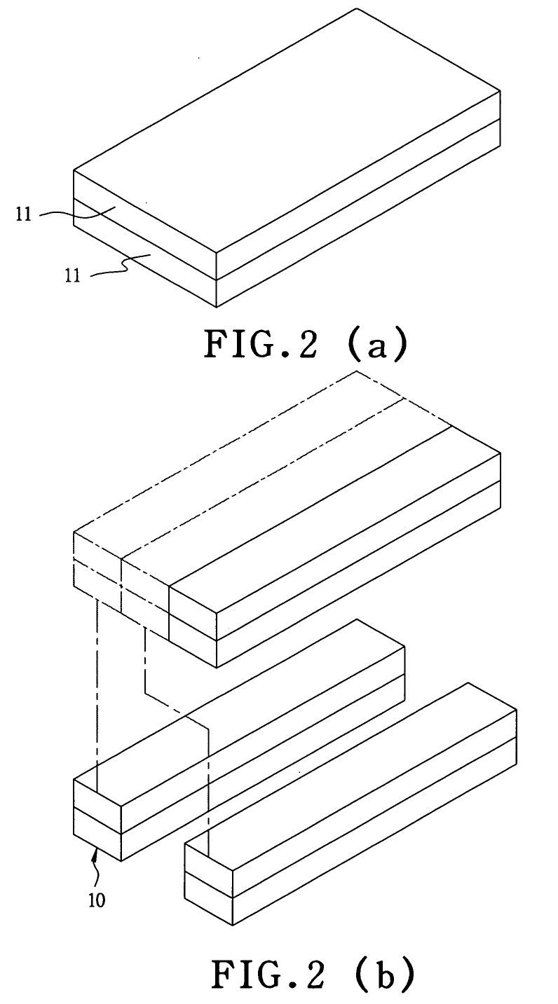

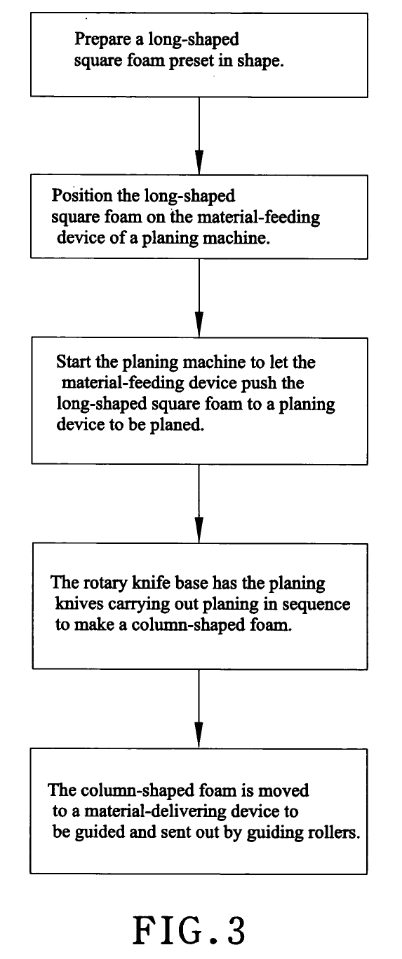

A preferred embodiment of a processing method for making column-shaped foam in the present invention, as shown in FIGS. 2 and 3, includes the following steps.

1. A first step: Prepare long-shaped square foam 10 preset in shape. The long-shaped square foam 10 is made of foam boards 11 produced by foaming per batch. According to a required thickness (i.e. the diameter of column-shaped foam required), the foam boards 11 are piled and bonded together by thermal fusing and then cut into long-shaped square foam 10.

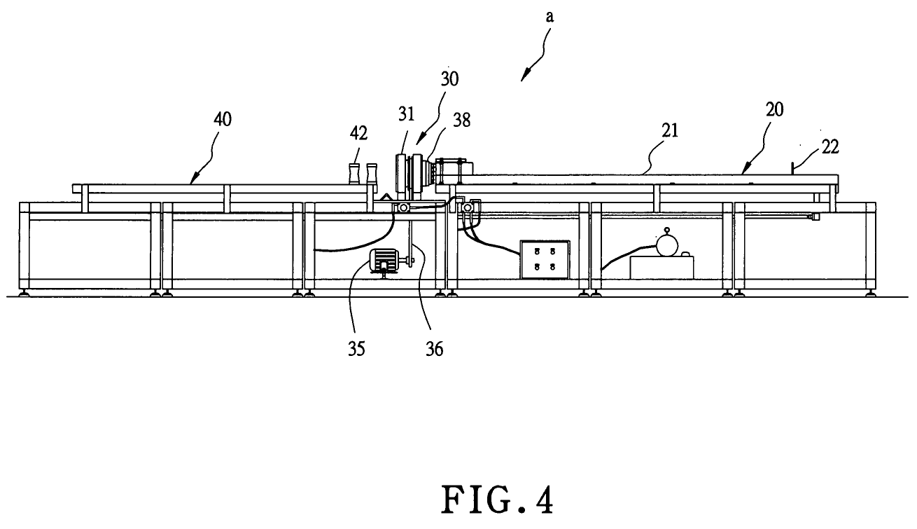

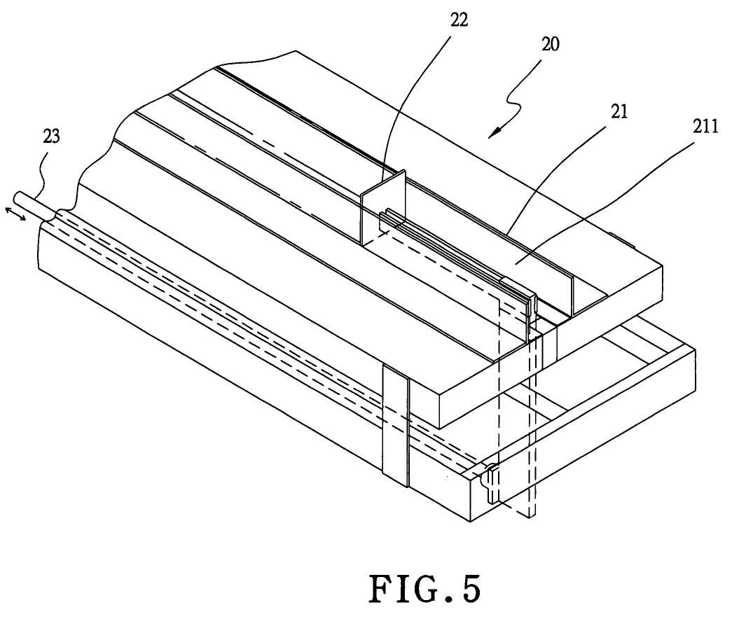

2. A second step: Place the long-shaped square foam 10 on the material-feeding device 20 of a planing machine (a). The planing machine (a), as shown in FIGS. 4 and 5, includes the material-feeding device 20, a planing device 30 and a material-delivering device 40. The material-feeding device 20 is provided with a guiding rail 21 formed with a rectangular groove 211 for receiving the long-shaped square foam 10. The guiding rail 21 is also provided thereon with a push plate 22 having its lower end connected with a push rod 23, which can be driven to push forward the push plate 22 together with the long-shaped square foam 10 on the guiding rail 21. Further, a position-limiting plate 24 adjustable in height is provided at a preset position above the front end of the guiding rail 21 for stopping and positioning the topside of the long-shaped square foam 10 in a planing process.

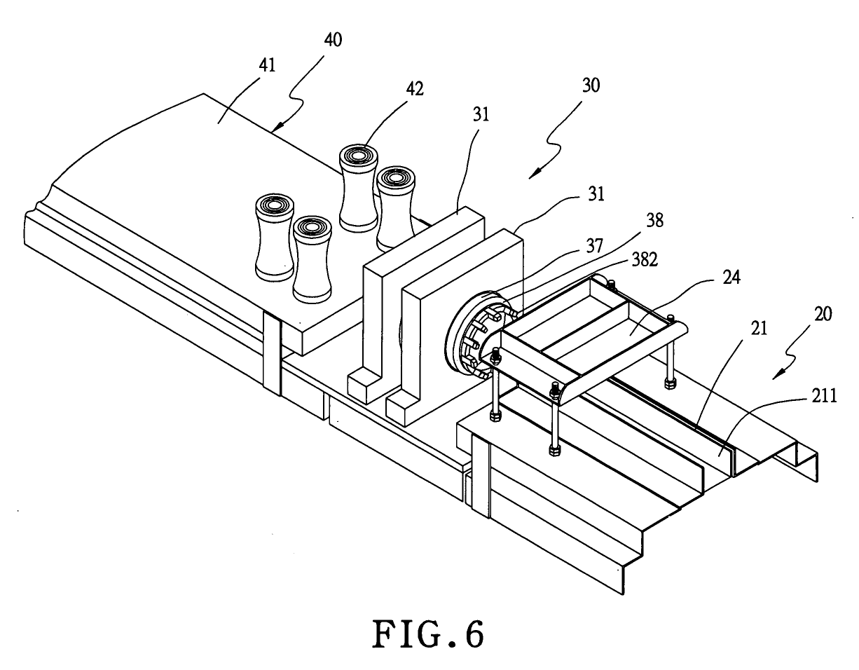

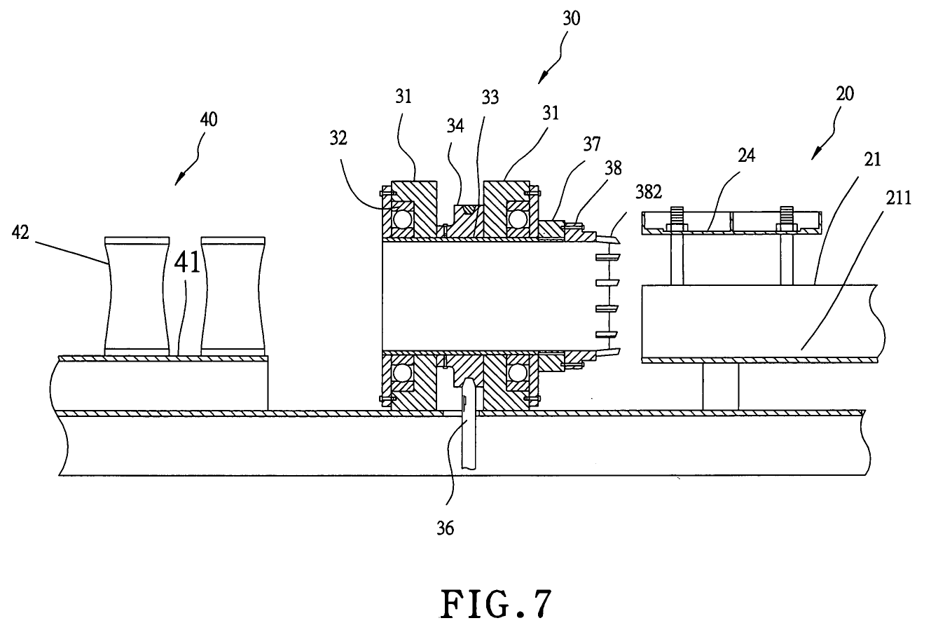

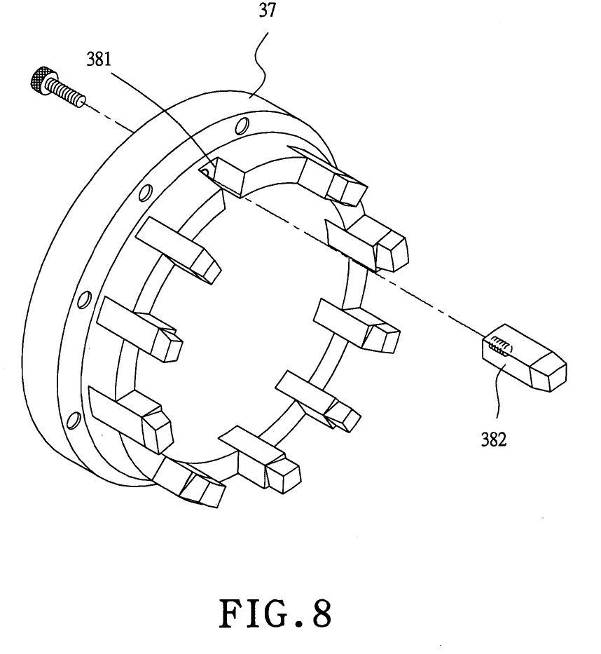

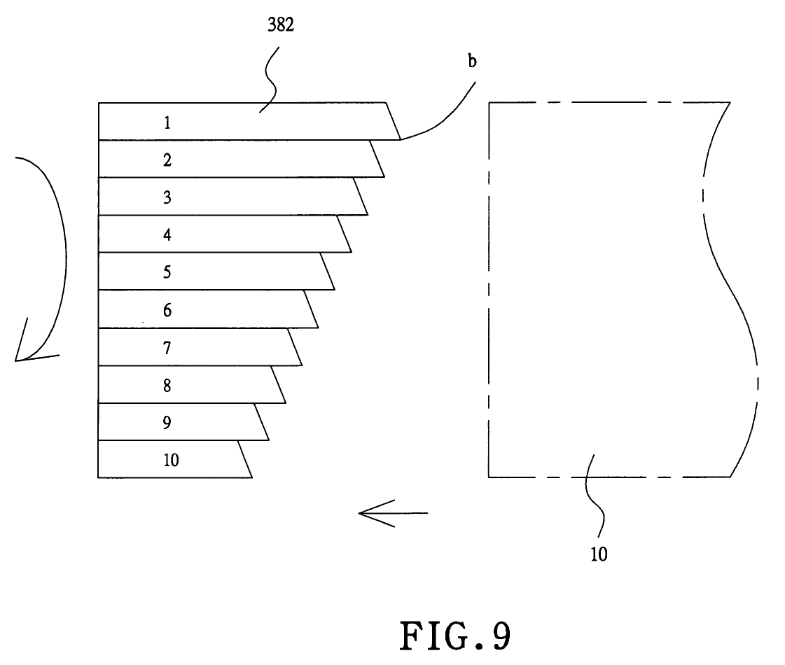

The planing device 30, as shown in FIGS. 6 and 7, includes two bearing bases 31 respectively provided with a bearing 32. A shaft tube 33 is axially provided at the central portions of the two bearings 32, and a belt pulley 34 is installed between the two bearing bases 31 and fixed on the shaft tube 33. The belt pulley 34 is driven to rotate together with the shaft tube 33 by a motor 35 and through a belt 36. Furthermore, the shaft tube 33 has its front outer wall secured with a transfer ring 37 having a knife base 38 fixed thereon sideward to rotate circularly. The knife base 38 has the circumferential wall of its outer end bored with ten knife grooves 381 spaced apart at a preset distance for ten planing knives 382 to be respectively fitted therein, as shown in FIG. 8. The ten planing knives 382 are arranged in order, different from each other in length and respectively numbered from 1 to 10, as shown in FIG. 9. The first planing knife 382 has its planing portion (b) at the outer end positioned comparatively near the long-shaped square foam 10 to be planed, the second planing knife 382 has its planing portion (b) at the outer end kept away at a little distance from the long-shaped square foam 10 and so forth, and the tenth planing knife 382 has its planing portion (b) at the outer end positioned farthest from the long-shaped square foam 10. The material-delivering device 40 includes a material-delivering flat stand 41 pivotally provided thereon with a plurality of guiding rollers 42 arranged in two rows opposite to each other for guiding and sending out a finished product.

3. A third step: Start the planing equipment (a) to drive the push rod 23 of the material-feeding device 20 to move forward and actuate the push plate 211 on the guiding rail 21 to push the long-shaped square foam 10 to the planing device 30 at a preset speed and at this time, the knife base 38 is driven by the motor 35 to rotate at a preset speed.

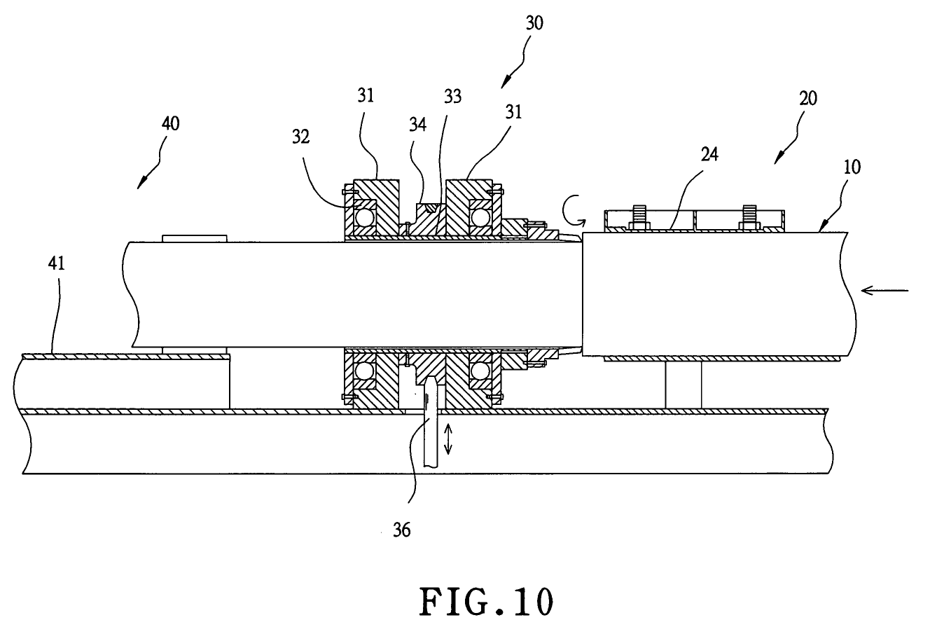

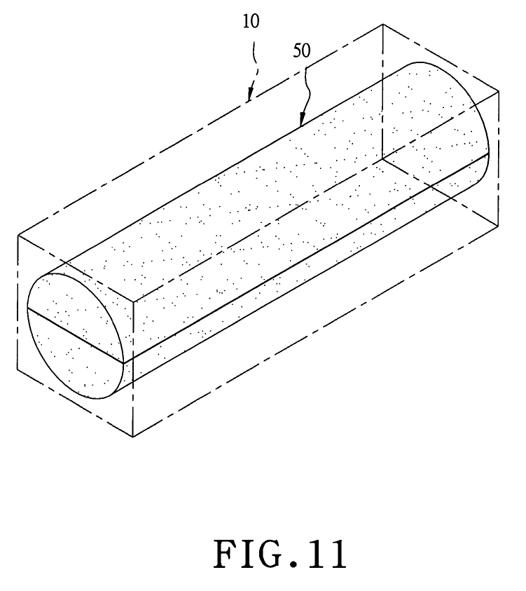

4. A fourth step: Actuate the planing knives 382 to carry out planing in proper sequence, as shown in FIGS. 10 and 11. After the long-shaped square foam 10 is pushed to the planing device 30, it will instantly contact first with the planing portion (b) of the first planing knife 382 on the knife base 38 to have its peripheral surface planed circularly by the first planing knife 382. Then, the long-shaped square foam 10 is continuously moved forward axially to be planed by the other orderly arranged planing knives 382, able to have the peripheral surface of the long-shaped square foam 10 planed into a smooth circumferential surface.

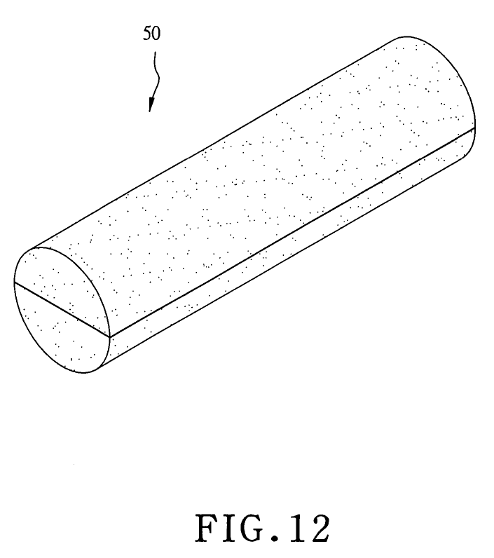

5. A fifth step: After the long-shaped square foam 10 is completely moved through the planing portions (b) of the ten planing knives 382 on the knife base 38, it will be planed into column-shaped foam 50. Subsequently, the column-shaped foam 50 is moved through the inner space of the shaft tube 33 of the planing device 30 and reaches a location between the two rows of the guiding rollers 42 of the material-delivering device 40 to be guided and sent out by the guiding rollers 42 to finish the process of making the column-shaped foam 50, as shown in FIG. 12.

As can be understood by the above description, this invention has the following advantages.

1. The column-shaped foam 50 of this invention is made by having a preset thermal-fused long-shaped foam 10 planed in shape by means of the planing machine (a), able to make a column-shaped foam quickly.

2. The rotary knife base 38 of this invention is provided thereon with ten planing knives 382 rotated to carry out planing in sequence, able to overcome rotating limitation of large diameters and carry out planing quickly and efficiently.

3. The planing knives 382 of the knife base 38 are able to smoothly plane the surface of the column-shaped foam 50 and make it really round. In addition, chips produced during planing are comparatively large and can be collected by vacuum cleaners, impossible to produce fine dust to pollute environment and endanger workers' health.

4. The column-shaped foam 50 is made of foam boards that are produced by foaming per batch and have fine closed air bubbles and thermal-fused together, cut and planed; therefore, the column-shaped foam 50 has excellent functions of floating, shock absorption and buffering, able to be extensively used for making related products, such as rhythmic rods, protective bumpers of a gunwale, buoys for a swimming pool and the like.

While the preferred embodiment of the invention has been described above, it will be recognized and understood that various modifications may be made therein and the appended claims are intended to cover all such modifications that may fall within the spirit and scope of the invention.

I claim: A processing method for making column-shaped foam comprising the following steps:

1. A first step: Preparing a long-shaped square foam preset in shape:

2. A second step: Said long-shaped square foam positioned on the material-feeding device of a planing machine, said planing machine comprising said material-feeding device and a planing device and a material-delivering device, said planing device provided thereon with a knife base having a plurality of planing knives spaced apart annularly, said planing knives having their planing portions at the outer ends respectively provided at different locations according to the sequence of rotating and planing of said knife base:

3. A third step: Starting said planing equipment to actuate said material-feeding device to push said long-shaped square foam to said planing device at a preset speed, said knife base simultaneously rotating at a preset speed:

4. A fourth step: Said planing knives actuated to carry out planing in sequence, said long-shaped square foam on said planing device contacting first with the first-positioned planing knife, said long-shaped square foam having its peripheral surface planed circularly by the planing portion of said first-positioned planing knife, said long-shaped square foam continuing to be moved forward axially and planed by the other planing knives that are arranged orderly according to their planing sequence, said long-shaped square foam having its peripheral surface planed into a smooth circumferential surface: and

5. A fifth step: Said long-shaped square foam able to be planed into a column-shaped foam after said long-shaped square foam completely passes through said knife base, said column-shaped foam guided and sent out through said material-delivering device, thus finishing the process of shaping said column-shaped foam.

2. The processing method for making column-shaped foam as claimed in claim 1, wherein said planing knives are of different lengths according to the sequence of their arrangements, said first-positioned planing knife having its planing portion at the outer end provided comparatively near said long-shaped square foam to be planed and so forth.

3. The processing method for making column-shaped foam as claimed in claim 1, wherein said long-shaped square foam is made of foam boards that are produced by foaming per batch and piled, thermal-fused and cut into shape.

4. The processing method for making column-shaped foam as claimed in claim 1, wherein said material-feeding device is provided with a guiding rail formed with a rectangular groove and provided in the center with a push plate connected with a push rod.

5. The processing method for making column-shaped foam as claimed in claim 1, wherein said planing device is provided with two bearing bases, and has a shaft tube axially provided at the central portions of said two bearing bases and a belt pulley provided between two said bearing bases and secured on said shaft tube, said belt pulley driven to rotate together with said shaft tube by a motor and through a belt, said shaft tube having the outer wall of one end fixed with a transfer ring secured thereon with said knife base able to rotate circularly together with said transfer ring.

6. The processing method for making column-shaped foam as claimed in claim 1, wherein said knife base has the circumferential wall of its outer end bored with a plurality of knife grooves spaced apart at a preset distance for said planing knives to be respectively fitted therein.

7. The processing method for making column-shaped foam as claimed in claim 1, wherein said material-delivering device is provided on the topside with a plurality of guiding rollers arranged in two rows opposite to each other for guiding and sending out finished said column-shaped foam.
